(19) United States
(12) Patent Application Publication
(10) Pub. No.: US 2009/0014107 A1
(43) Pub. Date: Jan. 15, 2009

(54) Disposable tire wheel cover

(76) Inventors: William Martin, Las Vegas, NV (US); Elizabeth Martin, Las Vegas, NV (US)

Correspondence Address: RYLANDER & ASSOCIATES PC, 406 WEST 12TH STREET, VANCOUVER, WA, 98660, US

(21) Appl. No.: 12/218,652

(22) Filed: Jul. 16, 2008

Related U.S. Application Data
(62) Division of application No. 11/607,247, filed on Nov. 30, 2006.
Application No. 11/607,247 is a continuation-in-part of application No. 10/854,860, filed on May 27, 2004, now abandoned.

(51) Int. Cl. B60C 27/16

(52) U.S. Cl. 152/185

(57) ABSTRACT

A disposable tire/wheel cover includes a round elastic material having a waterproof front face, a back face having a concentric hole, an elastic band around the concentric hole's perimeter, whereby the round elastic material can be removably attached to a tire or a wheel, and surface contact grips on the cover located where the cover comes into contact with the ground. A disposable tire/wheel cover also includes surface contact grips located where the cover comes into contact with a wheel or tire. A disposable tire/wheel cover also includes at least two elastic strips on the front face. A method for making a tire wheel cover, for floor protection. A disposable tire/wheel cover system utilizing a hollow container. A floor protecting dolly. A method for protecting floor surfaces. A floor protecting forklift.

### CROSS-REFERENCE TO RELATED APPLICATION

This application is a divisional of and claims priority to co-pending non-provisional application Ser. No. 11/607,247, filed Nov. 30, 2006, which in turn is a continuation-in-part of and claims priority to non-provisional application Ser. No. 10/854,860, filed May 27, 2004.

### FIELD OF THE INVENTION

The present invention relates to tire wheel covers. More particularly, the present invention relates to tire wheel covers for indoor use.

### BACKGROUND

In construction, moving, and heavy-lifting industries, it is often necessary to use mechanical or motorized lifts and carts inside a building to move heavy items. Movers, appliance installers, and construction workers frequently use hand trucks or dollies to transport furniture, appliances and other heavy items into a residence or commercial building. Larger or heavier items frequently require heavy motorized equipment, such as a forklift, for transport inside a building. Such transportation equipment may also include mobile air compressors, airless sprays, boom trucks or scissor lifts. A building's floor may consist of marble, wood, carpet, tile, vinyl or other decorative flooring which may be damaged by tire marks from this type of transportation equipment. Repairing and/or replacing the flooring may be quite costly.

Currently, rolls of plastic or cardboard sheets are placed upon the building's floor, before the transport equipment is brought into the building, to prevent tire marks from damaging the floor and the equipment tracking in dirt, water, grass, etc. . . . The plastic and cardboard, however, are time consuming and expensive to protect the flooring, particularly if the transport equipment need only make a single trip into the building. Furthermore, even after carefully laid down, the plastic and cardboard may be moved off the desired path by people and equipment within the building requiring additional time for repositioning. Moreover, people and equipment within the building may snag the plastic/cardboard resulting in injury to persons and property. Additionally, the plastic and cardboard must cover the entire floor or else the transportation equipment is limited in mobility to the plastic/cardboard path. Even when properly laid down in the correct path, the plastic/cardboard may become covered with water, dirt, grass, etc. . . . which the transportation equipment brings in. Additionally, when the transportation equipment tire is very large, it is difficult to find tire/wheel cover fabric or elastic in a corresponding size because commonly available fabric, cloth, and elastic is sold in bolts which are rarely over 60 inches (152.4 cm) in width.

Thus, there is a need for transportation equipment tire/wheel covers that are portable, made of simple construction, durable, easily cleaned, easily slipped on and off, tightly secured to the tire or wheel, provide traction, provide a portable dispenser, and can fit very large tires or wheels.

Presently known art attempts to address these problems, but has not completely solved them. The following represents a list of known related art:

| Reference: | Issued to: | Date: |
|---|---|---|
| U.S. Pat. No. 6,499,591 | Rizzo | December 2002 |
| U.S. Pat. No. 6,273,159 | Page | August 2001 |
| U.S. Pat. No. 822,177 | Bardou et al. | May 1906 |
| U.S. Pat. No. 1,303,224 | Atchmeyer | June 1919 |
| U.S. Pat. No. 1,755,133 | Wallace | April 1930 |
| U.S. Pat. No. 1,967,522 | Wengard | July 1934 |
| U.S. Pat. No. 5,044,411 | Doll | September 1991 |
| U.S. Pat. No. 5,439,727 | Riggs et al. | August 1995 |
| U.S. Pat. No. 6,142,192 | Dickinson et al. | November 2000 |
| U.S. Pat. No. 6,598,947 | Hannah | July 2003 |
| U.S. Pat. No. 4,126,169 | Magnuson et al. | November 1978 |
| U.S. Pat. No. 6,116,415 | Rastell | September 2000 |

The teachings of each of the above-listed citations (which does not itself incorporate essential material by reference) are herein incorporated by reference. None of the above inventions and patents, taken either singularly or in combination, is seen to describe the instant invention as claimed.

U.S. Pat. No. 6,499,591 to Rizzo teaches a tire wheel cover for golf carts, including a golf cart having a pair of wheels and a covering device for the golf cart wheels having a panel with a diameter between 15-24 inches (38.1-60.96 cm) and an elastic band creating an opening of less than 6 inches (15.24 cm).

U.S. Pat. No. 6,273,159 to Page teaches a wheel cover for preventing tire marks, including an elongated flexible piece of material, a connector for coupling the ends of the material to one another to cover the outside circumference of the tire, and a set of securing loops to secure the material to the tire.

Still other features would be desirable in a tire/wheel cover. For example, elastic strips transversing the center of the tire/wheel cover, surface contact grips on the portion of the tire/wheel cover that comes into contact with the ground or floor, a tire/wheel cover dispenser removably attached to the transportation equipment requiring the tire/wheel covers, a floor protecting dolly and a floor protecting forklift.

Thus, while the foregoing body of art indicates it to be well known to have a golf cart wheel cover and a tire tread strip, the art described above does not teach or suggest a tire/wheel cover which has the following combination of desirable features: (1) surface contact grips, (2) central elastic strips, (3) method for making tire/wheel covers to fit large transportation equipment, (4) tire/wheel cover dispenser, (5) floor protecting dolly, or (6) floor protecting forklift.

### SUMMARY AND ADVANTAGES

A disposable tire/wheel cover includes a round elastic material having a waterproof front face, a back face having a concentric hole, an elastic band around the concentric hole's perimeter, whereby the round elastic material can be removably attached to a tire or a wheel, and surface contact grips on the cover located where the cover comes into contact with the ground. A disposable tire/wheel cover also includes surface contact grips located where the cover comes into contact with a wheel or tire. A disposable tire/wheel cover also includes at least two elastic strips on the front face. A method for making a tire wheel cover, for floor protection. A disposable tire/wheel cover system utilizing a hollow container. A floor protecting dolly. A method for protecting floor surfaces. A floor protecting forklift.

The disposable tire wheel cover of the present invention presents numerous advantages, including: (1) use with a wide variety of transportation equipment, (2) security in the placement of the tire/wheel cover on the wheel, (3) security in the placement of the tire/wheel cover during use, (4) decreasing the likelihood of slides or falls, particularly when used on a slick or wet surface, (5) ease in carrying additional tire/wheel covers, (6) availability of tire/wheel covers when transportation equipment is used, (7) protection of floor surfaces, and (8) transportation equipment including a dolly or a forklift, that protects floor surfaces.

Additional advantages of the invention will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows a back view of an embodiment of the present invention.

FIG. 2 shows a front view of an embodiment of the present invention.

FIG. 3 shows another back view of an embodiment of the present invention.

FIG. 4 shows a perspective of a step for a method of making a tire/wheel cover.

FIG. 5 shows a front view of another step for a method of making a tire/wheel cover.

FIG. 6 shows a front view of yet another step for a method of making a tire/wheel cover.

FIG. 7 shows a perspective of an embodiment of the present invention in use.

FIG. 8 shows a perspective of an embodiment of the present invention in use.

FIG. 9 shows a perspective of an embodiment of the present invention in use.

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

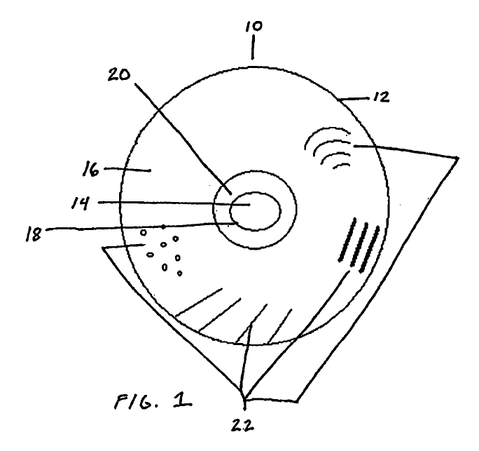

As shown in FIG. 1, a disposable tire/wheel cover 10 includes a round elastic material 12, a waterproof front face 14, a back face 16 having a concentric hole 18, and an elastic band 20 around the concentric hole's 18 perimeter, whereby the round elastic material can be removably attached to a tire or a wheel. In use, the tire/wheel cover 10 is placed on the tire or wheel of transportation equipment T which may include hand trucks, dollies, forklifts, mobile air compressors, airless sprays, boom trucks or scissor lifts.

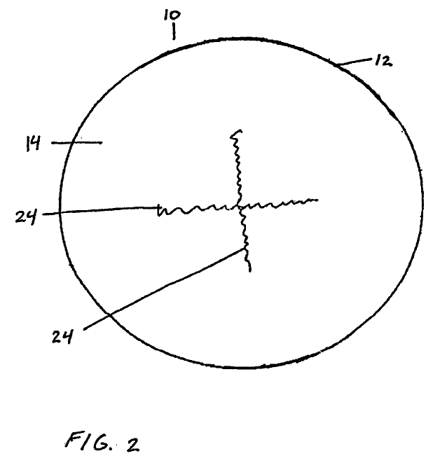

The disposable tire/wheel cover 10 may also include surface contact grips 22 on the cover 10, located where the cover 10 comes into contact with the ground or floor, see FIG. 1. The disposable tire/wheel cover 10 may also include surface contact grips 22 on the inside of the cover 10, located where the cover 10 comes into contact with a tire or wheel. The disposable tire/wheel cover 10 may also include at least two elastic strips 24 on the front face 14, as depicted in FIG. 2. The disposable tire/wheel cover 10 may also include traction on the round elastic material 12.

In the preferred embodiment, a disposable tire/wheel cover 10 includes a round elastic material 12, a waterproof front face 14, a back face 16 having a concentric hole 18, an elastic band 20 around the concentric hole's 18 perimeter, whereby the round elastic material can be removably attached to a tire or a wheel, surface contact grips 22 on the cover 10, located where the cover 10 comes into contact with the ground or floor, surface contact grips 22 on the cover 10, located where the cover 10 comes into contact with a tire or wheel, and at least two elastic strips 24 on the front face 14.

The round elastic material 12 may be made of cloth, fabric, plastic or elastic. In the preferred embodiment, the round elastic material 12 is urethane coated fabric to make the round elastic material 12 water resistant. The front face 14 is waterproof to protect the floor from tire or wheel marks as well as to protect the floor from the elements if the tire or wheel has been used outdoors.

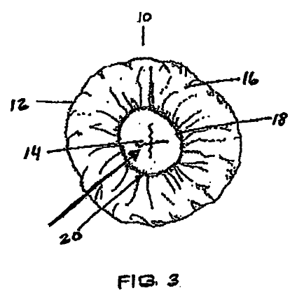

The elastic band 20, as shown in FIG. 3, is preferably ¼ of an inch (0.635 cm) wide and serge stitched around the concentric hole's 18 perimeter, thus causing the concentric hole 18 of the round elastic material's 12 back face 16 to form an opening 2-3 inches (5.08-7.62 cm) in diameter. When large tires or wheels are present on the transportation equipment T, it is necessary to create a concentric hole 18 with a larger opening, including a 30 inch (76.2 cm) opening for tires or wheels 79 inches (200.66 cm) in diameter.

Surface contact grips 22 may be protrusions and indents such as ridges, bumps (as shown in FIG. 1), bulges, knots, knobs, protuberances, ribs, tracks, channels, and grooves. Preferably, numerous surface contact grips 22 are located on the portion of the tire/wheel cover 10 which comes into contact with the ground or the floor. Surface contact grips 22 may be located on either the outside of the tire/wheel cover 10 to provide traction with the ground or floor, the inside of the tire/wheel cover 10 to provide the cover 10 traction with the wheel or both.

Traction may be made of plastic, rubber, metal, wood, cloth, fabric or elastic. Traction includes surface contact grips 22 and traction may be located on either the outside of the tire/wheel cover 10 to provide traction with the ground or floor or the inside of the tire/wheel cover 10 to provide the cover 10 traction with the wheel or tire.

Preferably, the traction or surface contact grips 22 allow the user to remove the tire/wheel cover 10 from the tire or wheel by pulling, without damaging (especially ripping or tearing) the tire/wheel cover 10, such that the tire/wheel cover 10 is removably attached to the tire or wheel.

Preferably, two elastic strips 24 are on the inside of the front face 14 and intersect at a ninety degree angle, without reaching the portion of the tire/wheel cover 10 which comes into contact with the tire tread, as depicted in FIG. 2, to provide maximum support for the disposable tire/wheel cover 10 when in place and prevent the elastic strips 24 from tearing or shredding under pressure. Preferably, the elastic bands 24 are straight stitched onto the inside of the front face 14. However, as shown in FIGS. 2 and 3, the elastic bands 24 appear in a zigzag pattern when tension is not applied to the tire/wheel cover 10. In use, the concentric hole 18 slips over the wheel and the elastic band 20 and the two elastic strips 24 all securely hold the tire/wheel cover 10 in place, particularly while the wheel is in motion over a rough and/or uneven surface. One with reasonable skill in the art would realize that more than two elastic strips 24 may be used.

In use, the concentric hole 18 is expanded by pulling on the elastic band 20 and then slipped over the tire/wheel such that the elastic band 20 is engaged and secures the entire tire/wheel cover 10 in place. The traction or surface grips 22 come into contact with the floor or ground when the wheel or tire is turning and increase friction, ensuring that neither the tire/wheel cover 10 nor the wheel or tire slips, even when exposed to a slippery surface. When traction or surface grips 22 are located on the inside of the tire/wheel cover 10, the traction or surface grips 22 come into contact with the tire or wheel once the cover 10 is in place, ensuring that neither the tire/wheel cover 10 nor the wheel or tire slips, even when exposed to a slippery surface. The user may ensure that the traction or surface grips 22 engage the tire or wheel by applying pressure to the cover 10 once the cover 10 is on the tire or wheel. When at least two elastic strips 24 are on the front face 14, the elastic strips 24 are engaged once the cover is in place on the tire or wheel. The user may need to apply tension to the elastic strips 24, lengthening them, at the same time the user expands the concentric hole 18, in order to slip the cover 10 over the tire or wheel.

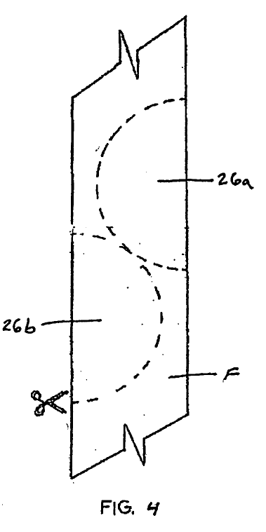

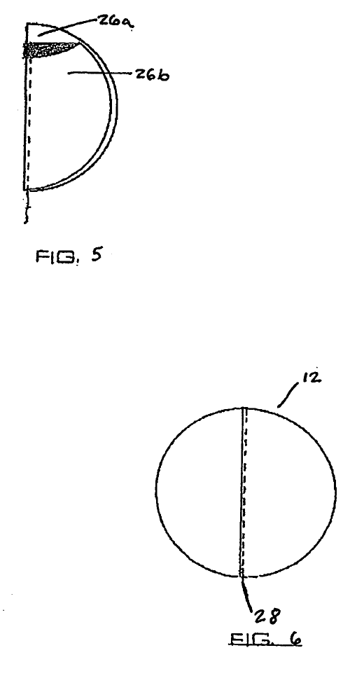

A method for making a tire/wheel cover 10, for floor protection, including cutting fabric F into two semicircular parts 26a, 26b, as shown in FIG. 4, fastening the two parts 26a, 26b together and creating a seam 28, as shown in FIG. 5, thereby forming a round elastic material 12, as depicted in FIG. 6, and fastening an elastic band 20 onto the round elastic material's 12 peripheral edge, as illustrated in FIG. 3.

Fasteners to fasten the two semicircular parts 26a, 26b together include ties, adhesives (including glue, tape and paste), thread, hooks, clips, clasps, clamps, snaps, buttons, string, wire, rope, screws, nuts, bolts, pins, hook and loop fasteners, and rivets. Fastening two semicircular parts 26a, 26b together is the preferred method for making a tire/wheel cover 10 when the wheel is over 5 feet (1.524 m) in diameter since cloth, fabric and elastic typically comes in widths less than 5 feet (1.524 m). Preferably, the two parts 26a, 26b are stitched together with thread and the resulting seam 28 is topstitched to prevent fraying and increase the seam's strength. Preferably, the elastic band 20 is serge stitched onto the round elastic material's 12 peripheral edge.

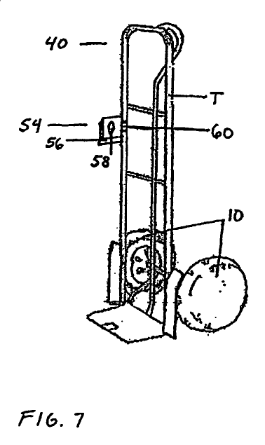

A disposable tire/wheel cover system 40 includes a disposable tire wheel cover 10, and a cover dispenser 54, having a hollow container 56, an opening 58 on the hollow container 56, whereby the tire/wheel cover 42 can be stored inside the hollow container 56 and removed via the opening 58 on the hollow container 56, and attachment means 60 whereby hollow container 56 can be attached to the transportation equipment requiring the tire/wheel cover 10. In one example, as depicted in FIG. 7, the transportation equipment T is a dolly and the attachment means 60 is a band fixed to the cover dispenser 54 and attached to the dolly frame. Again, the transportation equipment T may include hand trucks, dollies, forklifts, mobile air compressors, airless sprays, boom trucks or scissor lifts.

Such attachment means 60 may include fasteners such as: ties, adhesives (including glue, tape and paste), thread, hooks, clips, clasps, clamps, snaps, buttons, string, wire, rope, screws, nuts, bolts, pins, hook and loop fasteners, and rivets. Preferably, the hollow container 56 can carry several tire/wheel covers 10 at once, allowing the user to replace tire/wheels covers 10 as necessary in an efficient manner. It is also preferable that the hollow container 56 is attached so as not to interfere with the wheel movement or storage of items being transported.

The hollow container 56 can be of any shape including square, rectangular, round, triangular and polyhedronal. One of ordinary skill in the art would recognize that, depending on the transportation equipment T used, a variety of shapes and sizes would allow the user to attach the cover dispenser 54 without interfering with the use of the transportation equipment T.

A floor protecting dolly 80, as shown in FIG. 9, includes a mover's dolly 82, having at least two wheels 84, two or more flexible elastic wheel covers 10, each cover 10 fitted around a wheel 84, and an elastic band 20 holding each cover 10 tightly to its respective wheel 84. In use, the flexible elastic wheel covers 10 can be removed when the dolly 82 is transported outside and placed back on the wheels when the dolly 82 is brought indoors, to protect the flooring. In this embodiment, the flexible elastic wheel covers 10 are preferably made of a lightweight, spun-bounded or meltblown, non-woven fabric with a wetting agent.

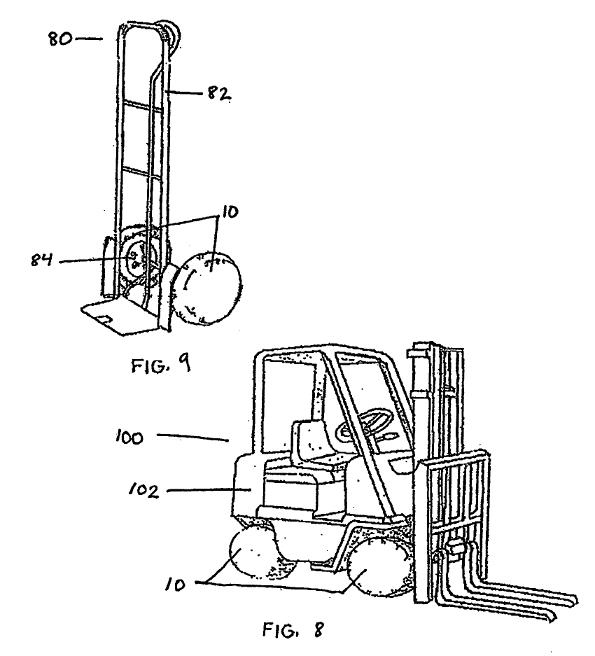

A floor protecting forklift 100, as depicted in FIG. 8, includes a forklift 102, having at least four wheels 104, four or more flexible elastic wheel covers 10, each cover 10 fitted around a wheel 104, and an elastic band 20 holding each cover 10 tightly to its respective wheel 10. In use, the flexible elastic wheel covers 10 can be removed when the floor protecting forklift 100 is transported outside and placed back on the wheels when the floor protecting forklift 100 is brought indoors, to protect the flooring. In this embodiment, the flexible elastic wheel covers 10 are preferably made of 600 Denier Polyester, which is durable enough to withstand a 5,000 lb (2268.0 kg) tire or wheel pivoting and turning.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

We claim:

1. A disposable tire/wheel cover system, comprising:
a disposable tire wheel cover; and
a cover dispenser, having a hollow container with an opening on said hollow container, whereby said cover can be stored inside said hollow container and removed via said opening on said hollow container, and attachment means whereby said hollow container can be attached to transportation equipment requiring said cover.

2. The apparatus of claim 1, wherein said disposable tire wheel cover, comprises a disposable round elastic material having a waterproof front face, a back face having a concentric hole, and an elastic band around said concentric hole's perimeter, whereby said round elastic material can be removably attached to a tire or a wheel.

3. The apparatus of claim 2, further comprising surface contact grips on said cover located where said cover comes into contact with the ground.

4. The cover of claim 2, further comprising surface contact grips on said cover located where said cover comes into contact with a tire or wheel.

5. The cover of claim 2, further comprising means for traction on said round (elastic material.

6. The cover of claims 2, further comprising at least two elastic strips on said front face.

7. The cover of claim 2, wherein the cover is made by a method comprising the steps of:
cutting disposable fabric into two semicircular parts;
fastening said two parts together thereby forming a round elastic material; and
fastening an elastic band onto said round elastic material's peripheral edge.

8. A floor protecting dolly, comprising:
a mover's dolly, having at least two wheels; and
two or more flexible elastic wheel covers, each said cover fitted around one of said wheels.

9. The apparatus of claim 8, wherein said disposable tire wheel cover, comprises a disposable round elastic material having a waterproof front face, a back face having a concentric hole, and an elastic band around said concentric hole's perimeter, whereby said round elastic material can be removably attached to a tire or a wheel.

10. The apparatus of claim 9, further comprising surface contact grips on said cover located where said cover comes into contact with the ground.

11. The cover of claim 9, further comprising surface contact grips on said cover located where said cover comes into contact with a tire or wheel.

12. The cover of claim 9, further comprising means for traction on said round elastic material.

13. The cover of claims 9, further comprising at least two elastic strips on said front face.

14. The cover of claim 9, wherein the cover is made by a method comprising the steps of:
cutting disposable fabric into two semicircular parts;
fastening said two parts together thereby forming a round elastic material; and
fastening an elastic band onto said round elastic material's peripheral edge.

15. A floor protecting forklift, comprising:
a forklift, having at least four wheels; and
four or more flexible elastic wheel covers, each said cover fitted around one of said wheels.

16. The apparatus of claim 15, wherein said disposable tire wheel cover, comprises a disposable round elastic material having a waterproof front face, a back face having a concentric hole, and an elastic band around said concentric hole's perimeter, whereby said round elastic material can be removably attached to a tire or a wheel.

17. The apparatus of claim 16, further comprising surface contact grips on said cover located where said cover comes into contact with the ground.

18. The cover of claim 16, further comprising surface contact grips on said cover located where said cover comes into contact with a tire or wheel.

19. The cover of claim 16, further comprising means for traction on said round elastic material.

20. The cover of claims 16, further comprising at least two elastic strips on said front face.

21. The cover of claim 16, wherein the cover is made by a method comprising the steps of:
cutting disposable fabric into two semicircular parts;
fastening said two parts together thereby forming a round elastic material; and
fastening an elastic band onto said round elastic material's peripheral edge.
